(19) United States
(12) Patent Application Publication
(10) Pub. No.: US 2003/0078872 A1
(43) Pub. Date: Apr. 24, 2003

(54) Dealing method enabling a deal clinching ratio

(76) Inventors: Shigehiko Terashima, Kawasaki-shi (JP); Kimiko Terashima, Shinjuku (JP)

Correspondence Address: STAAS & HALSEY LLP, 700 11TH STREET, NW, SUITE 500, WASHINGTON, DC, 20001, US

(21) Appl. No.: 10/127,703

(22) Filed: Apr. 23, 2002

(30) Foreign Application Priority Data
Oct. 12, 2001 (JP) 2001-315939

(51) Int. Cl. G06F 17/60

(52) U.S. Cl. 705/37

(57) ABSTRACT

A deal processing apparatus, which clinches a deal by intermediating a sell order and a buy order, comprises a sell/buy determining unit clinching a deal by determining a pair of sell and buy orders with which a deal is to be clinched. The sell/buy determining unit obtains a sell/buy profit by clinching a first deal with sell and buy orders in which a desired sell price is lower than a desired buy price. Then, the sell/buy determining unit clinches a second deal with sell and buy orders in which a desired buy price is lower than a desired sell price. A quantity to be dealt in the second deal is determined so that a sell/buy loss that a broker suffers in the second deal does not exceed the sell/buy profit that the broker obtains in the first deal. In this way, a deal is clinched while reducing the risk that a broker who intermediates orders with this dealing method suffers a sell/buy loss, even if a desired sell price of a sell order does not match a desired buy price of a buy order.

### BACKGROUND OF THE INVENTION

1. Field of the Invention

The present invention relates to a technique for smoothing brokerage operations with which a deal is clinched by intermediating sell and buy orders of a commodity ordered in a financial deal.

2. Description of the Related Art

Securities that are typified by a stock certificate are mainly dealt at a public exchange. Here, a stock certificate means a fund certificate issued by a stock company. An investor obtains a stockholder's right to vote and a right to receive a dividend by buying a stock certificate.

In a securities deal, the stocks of the same company are dealt at the same price by the same quantity. Here, both a seller and a buyer may be investors. Or, one of them may be an investor, and the other may be a broker. A deal made when both a seller and a buyer are investors is called a stock exchange deal, whereas a deal made when only one of a seller and a buyer is an investor is called an over-the-counter deal.

Securities are dealt at a public exchange such as the Tokyo Stock Exchange. However, at a public exchange, only an eligible member can clinch a deal. Therefore, a securities firm or an investor that is not a member must consign the selling/buying of a stock to a member who serves as a broker.

Meanwhile, as a result of abolishing exchange centralization rules, after a stock deal at a public exchange is terminated, for example, in Japan, a private exchange can be freely opened to deal such a stock. Unlike a public exchange that was set up by the Securities Dealers' Association, such a private exchange can accept an order not only from a securities firm that is a member of a public exchange, but also from a general investor who is not a member of a public exchange, and the like. Additionally, since the rules that are applied to the public exchanges have been eased, a private exchange can make a more flexible deal. For example, there is a private exchange that predetermines a sell price and a buy price which is cheaper than the sell price, buys a commodity at the buy price from a person who desires to sell the commodity, and sells the commodity to a person who desires to buy the commodity at the sell price which is higher than the buy price.

A broker of a securities deal earns an income as a commission each time a deal is clinched. Accordingly, a broker desires to increase the number of deals clinched.

However, with a conventional dealing method, a deal is clinched only when a stock of a company, and desired sell price and quantity, which are offered by a person who desires to sell the stock of the company, respectively match a stock, and desired buy price and quantity, which are bid by a person who desires to buy the stock. Therefore, it is difficult to expect a sharp increase in the number of deals clinched. For example, the deal clinching ratio indicating the ratio of sell and buy orders with which deals are clinched is said to be approximately 30 percent or lower among the number of sell and buy orders that brokers place to a public stock exchange in Japan. Remaining sell and buy orders with which a deal is not clinched are canceled upon termination of a deal at a exchange.

In contrast, a private exchange can directly accept sell and buy orders from investors. However, unlike brokers, most investors are difficult to continuously monitor the stock market in many cases. Accordingly, investors place, in most cases, an order that is unlikely to be settled, for example, a sell order at a desired price which is higher than buy and sell prices that are settled immediately before the order is placed, or a buy order at a desired price which is cheaper than the buy and the sell prices is placed. Accordingly, the deal clinching ratio becomes lower in comparison with the case of a public exchange.

### SUMMARY OF THE INVENTION

An object of the present invention is to provide a deal processing apparatus improving a deal clinching ratio by clinching a deal even if desired sell price and quantity do not a match desired buy price and quantity, while keeping the risk that a broker suffers a loss low, a dealing method, and a storage medium on which is recorded a program for causing a computer to execute the dealing method and the like.

According to one aspect of the present invention, a dealing method clinching a deal by intermediating sell and buy orders, comprises: clinching a first deal if a desired sell price of a sell order is lower than a desired buy price of a buy order in the first deal; calculating a sell/buy profit made by clinching the first deal; calculating a sell/buy loss incurred by clinching a second deal if a desired buy price of a buy order is lower than a desired sell price of a sell order in the second deal; and clinching the second deal if a value obtained by subtracting the sell/buy loss from the sell/buy profit is equal to or larger than a predetermined value.

As a result, a deal can be clinched while reducing the risk that a broker who intermediates orders suffers a sell/buy loss by using the above described dealing method, even if a desired sell price of a sell order does not match a desired buy price of a buy order. Consequently, a deal clinching ratio is improved, and a commission obtained by a broker can be increased.

The above described method may further comprise determining as a quantity to be dealt in the first deal a smaller quantity of a quantity of the sell order in the first deal and a quantity of the buy order in the first deal. Consequently, a deal can be clinched by a quantity that enables the deal, even if desired quantities of sell and buy orders do not match.

Additionally, the above described method may further comprise determining a quantity to be dealt in the second deal based on the desired sell/buy profit in the first deal, and the desired buy and sell prices in the second deal. To be more specific, the above described method further comprise: calculating a desired sell and buy price difference, which is a difference between the desired buy price of the buy order and the desired sell price of the sell order in the second deal; calculating an upper limit quantity to be dealt by dividing the sell/buy profit by the desired sell and buy price difference; and determining as a quantity to be dealt in the second deal the smallest quantity among the upper limit quantity to be dealt, the quantity of the sell order in the second deal, and the quantity of the buy order in the second deal.

Consequently, the quantity to be dealt in the second deal can be determined not to make a broker suffer a sell/buy loss that exceeds the sell/buy profit that the broker obtains in the first deal.

Furthermore, the above described method may further comprise: calculating a historical volatility of a commodity dealt in the first deal to time; calculating a historical volatility of a commodity dealt in the second deal to time; and not clinching the second deal if the historical volatility of the first commodity and that of the second commodity do not have a predetermined relationship. Here, the predetermined relationship may be, for example, a relationship between the historical volatilities of the first and the second commodities, which are within a predetermined range. Furthermore, if a commodity is a stock certificate, and if the industry type to which the first commodity belongs is not the same as the industry type to which the second commodity belongs, the second deal may not be clinched. As a result, sell and buy orders, which are to be targeted by the second deal, can be quickly selected.

The above described method may further comprise: setting a value obtained by subtracting the sell/buy loss from the sell/buy profit as a new sell/buy profit if the obtained value is larger than the predetermined value; and clinching a third deal where a desired buy price of a buy order is lower than a desired sell price of a sell order. If the sell/buy profit in the first deal still remains even after the second deal is clinched, the deal clinching ratio can be further improved by clinching an additional deal.

According to another aspect of the present invention, a dealing method clinching a deal by intermediating sell and buy orders comprises: clinching a first deal if a desired sell price of a sell order is higher than a desired buy price of a buy order in the first deal; calculating a sell/buy loss incurred by clinching the first deal; clinching a second deal if a desired buy price of a buy order is higher than a desired sell price of a sell order in the second deal; calculating a sell/buy profit made by the second deal; and clinching a third deal where a desired buy price of a buy order is lower than a desired sell price of a sell order if a value obtained by subtracting the sell/buy profit from the sell/buy loss is not equal to or smaller than a predetermined value. Also with this method, the above described problem can be overcome.

According to a further aspect of the present invention, a deal processing apparatus clinching a deal by intermediating sell and buy orders comprises: an accepting unit accepting sell and buy orders; and a sell/buy determining unit clinching a deal by determining a pair of sell and buy orders. The sell/buy determining unit clinches a first deal if a desired sell price of a sell order is lower than a desired buy price of a buy order in the first deal, calculates a sell/buy profit made by clinching the first deal, calculates a sell/buy loss incurred by clinching a second deal if a desired buy price of a buy order is lower than a desired sell price of a sell order in the second deal, and clinches the second deal if a value obtained by subtracting the sell/buy loss from the sell/buy profit is equal to or larger than a predetermined value. With such a configuration, an operation and an effect, which are similar to those obtained with the above described method, can be obtained, and the above described problem can be overcome.

Also a program for causing a computer to execute a process similar to functions executed by each of the above described configurations according to the present invention can overcome the above described problem by making the computer read and execute the program.

The above described problem can be also overcome by making a computer read and execute the above described program from a computer-readable storage medium on which is recorded the program.

### BRIEF DESCRIPTION OF THE DRAWINGS

The features and advantages of the present invention will be more clearly appreciated from the following description taken in conjunction with the accompanying drawings in which like elements are denoted by like reference numerals and in which:

FIG. 1 shows the configuration of a deal processing apparatus;

FIG. 2 exemplifies the data structure of an order data table;

FIG. 3 exemplifies the data structure of a historical volatility table;

FIG. 4 shows the configuration of a computer;

FIG. 5 is a flowchart showing the operations of a process performed by the deal processing apparatus;

FIG. 6 exemplifies a sell/buy order input screen;

FIG. 7 exemplifies an order inquiry screen; and

FIG. 8 explains storage media or a transmission signal, which can provide data and a program to a computer.

### DESCRIPTION OF THE PREFERRED EMBODIMENTS

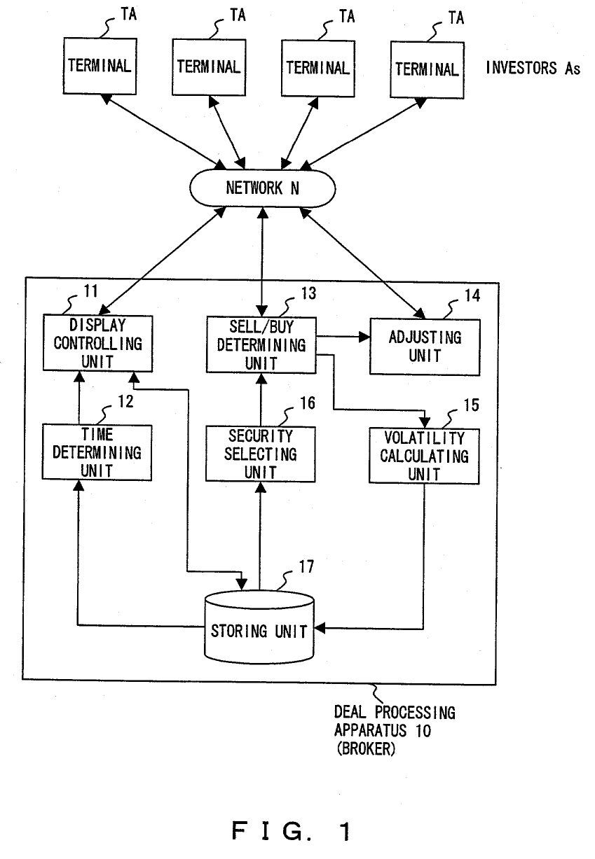

Hereinafter, a preferred embodiment according to the present invention is described with reference to the drawings. Configuration of a deal processing apparatus 10 that relates to this preferred embodiment is shown in FIG. 1. As shown in this figure, the deal processing apparatus 10 is connected to terminals TAs of investors As via a network N. As the network N, for example, the Internet, an analog telephony network, ISDN (Integrated Services Digital Network), xDLS typified byADSL (Asymmetric Digital Subscriber Line), awireless communications network, and the like can be considered.

An investor A inputs order data which indicates the contents of a sell/buy order to a terminal TA, and the order data is transmitted from the terminal TA to the deal processing apparatus 10 via the network N. Note that a broker may accept an order from an investor A by telephone or face-to-face, and may input the order data to the deal processing apparatus 10 by using an input device (not shown) comprised by the deal processing apparatus 10.

The deal processing apparatus 10 intermediates a deal between investors As based on the order data received from the investor A. With the deal processing apparatus 10 that relates to this preferred embodiment, a deal can be clinched at desired prices without predetermining sell and buy prices, if the desired sell price of a sell order and the desired buy price of a buy order have a predetermined relationship.

Constituent elements configuring the deal processing apparatus 10 are explained below. The deal processing apparatus 10 comprises a display controlling unit 11, a time determining unit 12, a sell/buy determining unit 13, an adjusting unit 14, a volatility calculating unit 15, a security selecting unit 16, and a storing unit 17.

The display controlling unit 11 performs a control for displaying a screen on a terminal TA of an investor A. For example, the display controlling unit 11 performs a control for displaying an order acceptance screen to accept an order from an investor A on the terminal TA of the investor A, and stores the order data indicating the contents of the order in an order data table (to be described later) within the storing unit 17 if the order is accepted from the investor A. Additionally, the display controlling unit 11 performs, for example, a control for displaying an order inquiry screen to inquire about an order on the terminal TA, and obtains from the storing unit 17 the order data of the order identified based on the input from the investor A. Then, the display controlling unit 11 performs a control for transmitting the obtained order data to the terminal TA of the investor A, and for displaying the data on the terminal TA of the investor A.

The time determining unit 12 manages the start and the end of a deal process performed by the deal processing apparatus 10 based on a time.

The sell/buy determining unit 13 determines a deal to be clinched based on the order data accepted from the investor A. Deals clinched by the sell/buy determining unit 13 include three forms. A deal in the first form is a deal that is clinched if a match is found between stocks of companies, and desired prices and quantities of sell and buy orders in a similar manner as in a conventional technique. In this case, a broker possessing the deal processing apparatus 10 earns a commission as an income. Since the details of an explanation about the deal in this form are the same as those of a deal implemented by a conventional technique, they are omitted.

A deal in the second form is a deal that is clinched with sell and buy orders by a smaller quantity of desired sell and buy quantities, if a desired buy price is equal to or higher than a desired sell price in the sell and the buy orders of the stock of the same company. For a larger desired quantity in the sell and the buy orders, a quantity equivalent to the difference between the desired quantity and the quantity by which a deal is clinched remains as an order.

In the case of the deal in the second form, the deal processing apparatus 10 sells the ordered stock of the company at the desired buy price for the buy order, and buys the ordered stock of the company at the desired sell price for the sell order. Accordingly, if a deal in the second form is clinched, a broker earns as an income the amount of money equivalent to the value that is obtained by multiplying the difference between desired buy and sell prices by a quantity by which a deal is clinched, in addition to a commission.

A deal in the third form is a deal that is clinched with sell and buy orders of the stock of the same company if a desired sell price is equal to or higher than a desired buy price, reverse to the deal in the second form. Also in the case of the deal in the third form, the deal processing apparatus 10 sells the stock ordered of the company at the desired buy price for the buy order, and buys the stock of the company ordered at the desired sell price for the sell order. If the deal in the third form is clinched, a broker can earn a commission as an income, but suffers a loss by the amount of money equivalent to the value that is obtained by multiplying the difference between desired buy and sell prices by a quantity by which a deal is clinched.

Therefore, the deal processing apparatus 10 clinches a deal in the third form to reduce an economic risk that the broker suffers, if the sell/buy profit made by the deal in the second form exists. A quantity to be dealt in the deal in the third form may be determined so that the sell/buy loss incurred by the deal in the third form does not become larger than the sell/buy profit that the broker obtains in the deal in the second form. Deals in the second and the third forms will be described in detail later.

The adjusting unit 14 performs a settlement process for a deal clinched by the sell/buy determining unit 13. For example, if a sell order is settled, the adjusting unit 14 subtracts a commission from a sell cost equivalent to a desired sell price, and transfers the cost to the account of the investor A who placed the order. Or, for example, if a buy order is settled, a commission and a buy cost equivalent to a desired buy price are drawn from the account of the investor A who placed the order. Since this settlement process is obvious, its detailed explanation is omitted.

A stock of a company dealt by deals in the first to the third forms may be an arbitrary stock of a company However, a predetermined condition may be set up for a stock of a company to be dealt in the second and the third forms. For example, a condition that historical volatilities of a dealt stock of a company to time in the deals in the second and the third forms are within a predetermined range may be set up.

To implement this, the volatility calculating unit 15 calculates a historical volatility of each stock to time at a public exchange, and stores the calculated historical volatility in a historical volatility table (to be described later) within the storing unit 17. The security selecting unit 16 generates a pair of stocks of companies whose historical volatilities are within a predetermined range of each other. Then, the security selecting unit 16 registers the numbers of the stocks configuring the pair generated to the historical volatility table. The sell/buy determining unit 13 extracts an order for the stock paired with the stock dealt in the second deal from the order data table within the storing unit 17, and determines sell and buy orders to be targeted by the deal in the third form.

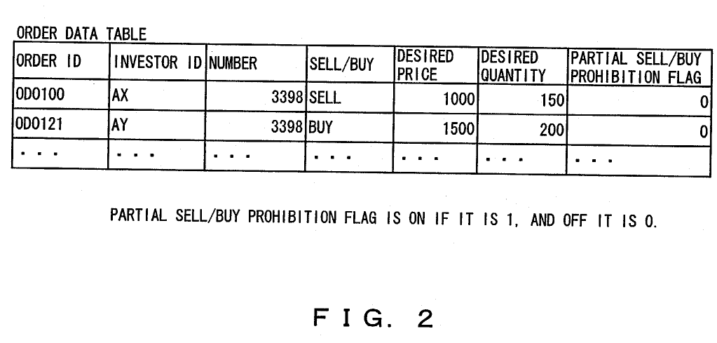

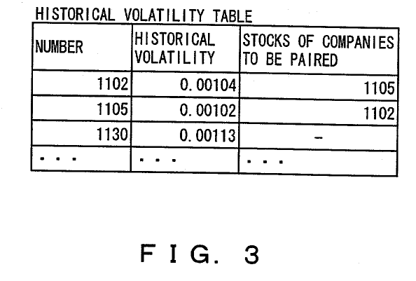

The storing unit 17 includes an order data table for storing order data of each order, and a historical volatility table for storing the historical volatility of each stock. Data structures of the order data table and the historical volatility table are explained below with reference to FIGS. 2 and 3. FIG. 2 exemplifies the data structure of the order data table. The order data table stores order data. As shown in FIG. 2, the order data stored in the order data table includes as entries an order ID for identifying an order, an investor ID for identifying an investor A who places an order, a number (or a symbol) for identifying an ordered stock of a company, sell/buy of an order, a desired price, a desired quantity, and a partial sell/buy prohibition flag indicating whether or not to prohibit only part of an ordered quantity. The following explanation is provided by assuming that the buying/selling of only part of an ordered quantity is prohibited if the partial sell/buy prohibition flag is ON (1).

Order data is registered to the storing unit 17 by the display controlling unit 11 upon acceptance of an order. The entries other than the order ID within the order data are based on the information received from an investor A. The order ID is assigned to an order by the display controlling unit 11 upon receipt of the order, registered to the order data table, and notified to the investor A who placed the order. The investor A can use the notified order ID, for example, when inquiring about the order. Additionally, the following explanation assumes that the valid term of an order is one day in principle. However, an arbitrary valid term may be set when an investor A places an order.

The data structure of the historical volatility table is exemplified in FIG. 3. As shown in this figure, the historical volatility table stores the historical volatility of each stock of a company, and the number (or the symbol) of a stock of a company paired with each stock of a company. The historical volatility is calculated by the volatility calculating unit 15 based on a result of a deal made at a public exchange, and registered to the historical volatility table. The numbers of stocks of companies to be paired with each stock of company are determined by the security selecting unit 16 based on the historical volatility, and registered to the historical volatility table.

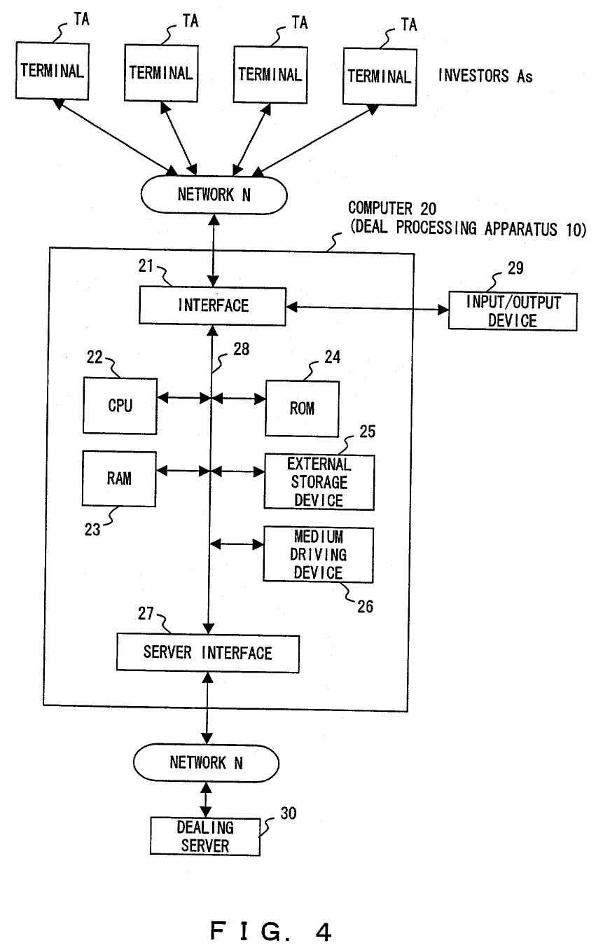

The above described deal processing apparatus 10 can be implemented by using a computer. Configuration of the computer that implements the deal processing apparatus 10 is shown in FIG. 4. As shown in this figure, the computer 20 comprises an interface 21, a CPU 22, a RAM (Random Access Memory) 23, ROM (Read-Only Memory) 24, an external storage device 25, a medium driving device 26, and a server interface 27, which are interconnected by a bus 28.

The interface 21 connects terminal TAs of investors As and the computer 20 via a network N. The interface 21 also connects the computer 20 and an input/output device 29.

The RAM 23 stores variable data of a control program, etc. The ROM 24 stores a control program representing the processes performed by the display controlling unit 11, the time determining unit 12, the sell/buy determining unit 13, the adjusting unit 14, the volatility calculating unit 15, and the security selecting unit 16, which configure the deal processing apparatus 10.

The CPU 22 executes the control program by using the ROM 24 and the RAM 23. The external storage device 25 corresponds to the above described storing unit 17, and is, for example, a magnetic disk device, an optical disk device, a magneto-optical disk, etc. The above described control program and data may be stored onto the external storage medium 25, and used by being loaded into the RAM 24, etc.

The medium driving device 26 drives a portable storage medium not shown, and accesses its stored contents. As the portable storage medium, an arbitrary computer-readable storage medium such as a memory card, a memory stick, a flexible disc, a CD-ROM (Compact Disk-Read-Only Memory), an optical disc, a magneto-optical disc, a DVD (Digital Versatile Disk) etc. is used. The above described control program and data are stored onto the portable storage medium, and can be used by being loaded into the RAM 23, etc.

The server interface 27 connects a different server 30 that accepts an order from an investor A not shown, or the like and the computer 20 via the network N. The configuration where the computer 20 comprises the two interfaces is shown in FIG. 4. However, the computer 20 may comprise one interface or three interfaces or more.

The input/output device 29 is, for example, a keyboard, a pointing device, a touch panel, etc., or a display, a printer, etc., and is used to input an instruction or information from a user or to output a result of a process performed by the computer 20, or the like.

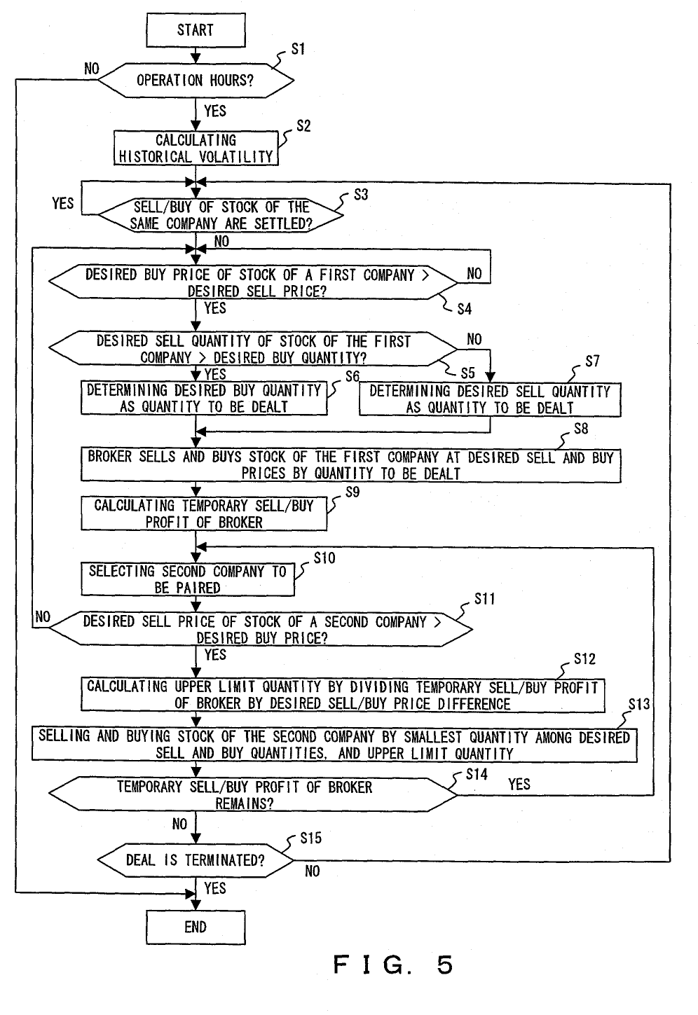

Next, the process performed by the deal processing apparatus 10 is described with reference to FIG. 5. Explanation is sometimes provided below by assuming that the deal processing apparatus 10 adopts a GUI (Graphical User Interface). However, this is not intended to limit the present invention.

In the following explanation, the deal processing apparatus 10 accepts an order from an investor A via the network N all the time in principle, and registers the order data of the accepted order to the storing unit 17. Since a deal in the first form, which is the same as a conventional deal form, among the above described three deal forms is obvious, its details are not referred to in the following procedural steps.

As shown in FIG. 5, the time determining unit 12 of the deal processing apparatus 10 first determines whether or not the current time is the operation hours of a private exchange at which the deal processing apparatus 10 is installed, based on a clock that is comprised by the deal processing apparatus 10 and not shown (step S1). If the timing determining unit 12 determines that the current time is not the operation hours of the private exchange (“NO” in step S1), it terminates the process. If the time determining unit 12 determines that the current time is the operation hours of the private exchange (“YES” in step S1), the volatility calculating unit 15 calculates the historical volatility of each stock of a company based on the deal price at a public exchange for a predetermined time period (step S2).

The historical volatility is a standard deviation of a deal price for a predetermined time period. Assuming that a weighted average price is p(i) of the price of a stock of a company in a period i (i=1, 2, . . . , n) in the case where the predetermined time period is divided into n periods, an average volatility u(i) is calculated with the following equation.

u(i)=log{p(i)/p(i−1)}

Also assuming that the weighted average volatility of u(i) is um, the historical volatility hv can be calculated with the following equation by using u(i) and um. A simple average may be used instead of the weighted average volatility um of u(i).

$$h {v}^{2} = \frac{{\sum }_{i = 1}^{n - 1} {( u ( i ) - u m )}^{2}}{n - 1}$$

A method calculating a historical volatility is specifically described below by using numerical values. Assume that a stock of a company is dealt at a deal price 1010 yen by a quantity of 5000, at 1000 yen by a quantity of 5000, and at 1020 yen by a quantity of 5000 for a certain time period. In this case, the weighted average price for this time period results in 1010 yen according to the following equation.

(1010×5000+1000×5000+1020×5000)/15000=1010

Also assume that the following results are similarly obtained as a result of calculating the weighted average price for a certain time period.

weighted average price p(1) in the morning of 1st: 1000

weighted average price p(2) in the afternoon of 1st: 1010

weighted average price p(3) in the morning of 2nd: 1010

weighted average price p(4) in the afternoon of 2nd: 1010

weighted average price p(5) in the morning of 3rd: 1010

weighted average price p(6) in the afternoon of 3rd: 1010

weighted average price p(7) in the morning of 4th: 1010

weighted average price p(8) in the afternoon of 4th: 1010

weighted average price p(9) in the morning of 5th: 1010

weighted average price p(10) in the afternoon of 5th: 1010

In this case, (weighted average price in a period)/(weighted average price immediately before the period)=pi/p(i−1) becomes as follows.

| in the morning of 1st: | NA |
|---|---|
| in the afternoon of 1st: | 1.010 |
| in the morning of 2nd: | 1.000 |
| in the afternoon of 2nd: | 1.000 |
| in the morning of 3rd: | 1.000 |
| in the afternoon of 3rd: | 1.000 |
| in the morning of 4th: | 1.000 |
| in the afternoon of 4th: | 1.000 |
| in the morning of 5th: | 1.000 |
| in the afternoon of 5th: | 1.000 |

Thereafter, u(i) can be calculated with the above provided two equations, and then, hv can be calculated. The volatility calculating unit 15 stores the calculated historical volatility in the historical volatility table within the storing unit 17. Then, the security selecting unit 16 selects a different stock of a company having a historical volatility that is close to the historical volatility of each stock of a company based on the calculated historical volatility, and stores the number of the selected stock of a company in the historical volatility table within the storing unit 17. The security selecting unit 17 may select the above described different stock from among stocks of companies which belong to the same industry type as that of each stock of a company.

In an exchange market of securities such as a stock certificate, a stock price rises or drops according to business results such as an ordinary profit and loss, etc. of a stock company. However, the business results of a stock company are much more influenced by the operating measures of a corporate manager than by the global economy. For example, if the price of WTI (West Texas Intermediate) in the North America rises, the import price of oil that is a fuel for producing electric power increases. Consequently, the ordinary profits and losses of Japanese power companies are deteriorated. There is a strong tendency such that the stock prices of stock companies of the same industry type have close historical volatilities. For this reason, the security selecting unit 16 can quickly select a stock the historical volatility of which is close. Furthermore, the security selecting unit 16 may select a stock based on the quantity of issued securities or an average deal price in addition to an industry type.

Then, the buy/sell determining unit 13 references the order data table, and searches for a pair of sell and buy orders whose desired prices and quantities match for a stock of the same company (step S3). If an order pair is obtained as a result of the search, the sell/buy determining unit 13 clinches a deal with the order pair, and outputs the order data of the orders of the clinched deal to the adjusting unit 14. Furthermore, the sell/buy determining unit 13 deletes the order data of the orders with which the deal is clinched from the order data table within the storing unit 17 (“YES” in step S3). This deal is a deal in the above described first form, and its processing method is similar to a conventional method. Therefore, its detailed explanation is omitted. Abroker earns a commission by clinching this deal, and does not suffer a sell/buy loss. The sell/buy determining unit 13 repeats the operation of step S3 as far as a pair of sell and buy orders whose desired prices and quantities match can be obtained for a stock of the same company.

If a pair of sell and buy orders whose desired prices and quantities match for the stock of the same company cannot be obtained (“NO” in step S3), the sell/buy determining unit 13 further determines whether or not to be able to generate a pair of orders of a stock of the same company, in which a desired buy price is higher than a desired sell price (step S4). If a pair of buy and sell orders of the stock of the same company, in which the desired buy price is higher than the desired sell price, cannot be generated (“NO” in step S4), the sell/buy determining unit 13 waits until such an order pair can be generated by registering new order data to the order data table.

Since the deal price in a deal that is clinched from moment to moment is open to investors As, etc. at a public exchange, orders in which a desired buy price offered by an investor A, etc. is higher than a desired sell price (that is, the case where a broker can obtain a profit) are difficult to occur. However, at a private exchange where a deal price is not open, such orders can possibly occur. Furthermore, the above described orders can possibly occur also in an after-hours deal that is made not via a trading floor or a selling/buying system at a public exchange. This is because a deal price is not open also in these cases.

If “YES” in step S4, the sell/buy determining unit 13 further determines whether or not a desired sell quantity of the sell order is larger than a desired buy quantity of the buy order for the pair of sell and buy orders, which is obtained in step S4 (step S5). If the desired sell quantity of the sell order is larger than the desired buy quantity of the buy order (“YES” in step S5), the sell/buy determining unit 13 determines the same quantity as the desired buy quantity to be a quantity to be dealt (step S6). Otherwise (“NO” in step S5), the sell/buy determining unit 13 determines the same quantity as the desired sell quantity to be a quantity to be dealt (step S7).

After step S6 or S7, the sell/buy determining unit 13 determines whether or not to be able to make a deal by the determined quantity to be dealt based on a partial sell/buy prohibition flag included in the order data of the sell and the buy orders. If the sell/buy determining unit 13 determines not to be able to make the deal, the process goes back to step S4. If the sell/buy determining unit 14 determines to make the deal, the process proceeds to step S8 (not shown).

To be more specific, if the desired buy quantity is determined to be the quantity to be dealt in step S6, the sell/buy determining unit 13 references the order data of the sell order, and determines whether or not the partial sell/buy prohibition flag included in the order data is ON. If the partial sell/buy prohibition flag is ON, part of the sell order cannot be settled. Accordingly, since the sell/buy determining unit 13 cannot clinch a deal, the process goes back to step S4. Or, if the desired sell quantity is determined to be the quantity to be dealt, the sell/buy determining unit 13 references the order data of the buy order, and determines whether or not the partial sell/buy prohibition flag is ON. If the partial sell/buy prohibition flag is ON, the process goes back to step s4.

Next, the sell/buy determining unit 13 sells the stock of the company at the desired buy price by the quantity to be dealt to the investor A who placed the buy order, and buys the stock of the company at the desired sell price by the quantity to be dealt from the investor A who placed the sell order (step S8). This deal corresponds to a deal in the above described second form. The sell/buy determining unit 13 outputs the order data of the orders with which the deal is clinched to the adjusting unit 14, and deletes the order data of the orders with which the deal is clinched from the order data table within the storing unit 17.

If the desired quantities of the sell and the buy orders are not the same, part of the order the desired quantity of which is larger is not dealt and remains. The sell/buy determining unit 13 generates, based on the order data of the order part of which is not dealt and remains, new order data in which the difference between the desired quantity of the original order and the quantity to be dealt is determined to be a desired quantity, and registers the new order data to the order data table within the storing unit 17 (not shown).

Furthermore, the sell/buy determining unit 13 calculates a temporary sell/buy profit that a broker who administers the deal processing apparatus 10 obtains as a result of this deal based on the desired sell price, the desired buy price, and the quantity to be dealt. At this time, the broker can obtain not only the sell/buy profit but also a commission of the deal. Since a commission calculation method is obvious, its explanation is omitted. A sell/buy profit calculation equation is as follows.

$$\begin{matrix}temporary sell \text{/} buy profit = \{ ( desired buy price ) - \\ ( desired sell price ) \} \times \\ ( quantity to be dealt )\end{matrix}$$

Then, the security selecting unit 16 references the historical volatility table within the storing unit 17, and obtains the number (or symbol) of the stock of the company whose historical volatility is close to the stock of the company dealt in step S8 (step S10). Here, the stock of the same company as the stock of the company dealt in step S8 may be obtained.

Next, the sell/buy determining unit 13 extracts the order data of the stock of the company obtained in step S10 from the order data table within the storing unit 17. Then, the sell/buy determining unit 13 determines whether or not to be able to generate an order pair in which a desired sell price of a sell order is higher than a desired buy price of a buy order among the extracted order data (step S11). If the sell/buy determining unit 13 determines not to be able to generate such an order pair (“NO” in step S11), the process goes back to step S4.

If the sell/buy determining unit 13 determines to be able to generate an order pair in which the desired sell price of the sell order is higher than the desired buy price of the buy order (“YES” in step S11), the process proceeds to step S12. If a plurality of order pairs can be generated, the sell/buy determining unit 13 may preferentially generate a pair in which the difference between desired sell and buy prices is the smallest (not shown). In this way, more deals can be clinched, whereby a broker can further earn a deal commission.

In step S12, the sell/buy determining unit 13 calculates the upper limit of a quantity to be dealt based on the temporary sell/buy profit calculated in step S9, and the desired sell and buy prices of the orders included in the order pair generated in step S11. This quantity is a quantity to be dealt when the temporary sell/buy profit calculated in step S9 results in 0 if a deal is made at the desired sell and buy prices. Its calculation equation is as follows. The above explanation is provided based on the assumption that the quantity to be dealt when the sell/buy profit results in 0 is defined to be the upper limit quantity. However, the sell/buy profit may be a predetermined value other than 0. In this case, a value obtained by subtracting the predetermined value from the sell/buy profit obtained in step S9 is defined to be a numerator in the following equation.

$$\begin{matrix}\begin{matrix}the upper limit of a \\ quantity that can be dealt\end{matrix} = ( temporary sell \text{/} buy profit ) / \\ \{ ( desired sell price ) - \\ ( desired buy price ) \}\end{matrix}$$

The sell/buy determining unit 13 determines as a quantity to be dealt the smallest quantity among the upper limit quantity and the desired sell and buy quantities of the order pair generated in step S11. Namely, the sell/buy determining unit 13 determines to clinch a deal that incurs a sell/buy loss by the quantity to be dealt, which does not exceed the sell/buy profit made by the preceding deal. As a result, a broker can appropriate the sell/buy profit made by one deal for the sell/buy loss incurred by another.

Then, the sell/buy determining unit 13 determines whether or not to be able to make a deal by the determined quantity to be dealt based on the partial sell/buy prohibition flag included in the order data of the sell and buy orders. If the sell/buy determining unit 13 determines not to be able to make the deal, the process goes back to step S10. Or, if the sell/buy determining unit 13 determines to be able to make the deal, the process proceeds to step S13 (not shown).

In step S13, the sell/buy determining unit 13 clinches the deal in a similar manner as in step S8. Namely, the sell/buy determining unit 13 sells the stock of the company at the desired buy price to the investor A who placed the buy order, and buys the stock of the company at the desired sell price by the quantity to be dealt from the investor A who placed the sell order. This deal corresponds to a deal in the above described third form. A broker can earn a commission as a profit, but suffers a sell/buy loss.

Furthermore, the sell/buy determining unit 13 deletes the order data of the orders with which the deal is clinched from the order data table within the storing unit 17, generates, for the order part of which is not dealt and remains, new order data in which the difference between the desired quantity of the original order and the quantity to be dealt is determined to be a desired quantity, based on the order data of that order, and registers the new order data to the order data table within the storing unit 17 (not shown).

Then, the sell/buy determining unit 13 calculates the sell/buy loss incurred by the deal made in step S13 by using an equation similar to the sell/buy profit calculation equation in step S9. Then, the sell/buy determining unit 13 subtracts the sell/buy loss incurred by the deal made in step S13 from the temporary sell/buy profit calculated in step S9. Furthermore, the sell/buy determining unit 13 determines whether or not the value resultant from the subtraction is a value larger than 0 or a predetermined value (step S14). If the value resultant from the subtraction is larger than 0 or the predetermined value (“YES” in step S14), the sell/buy determining unit 13 sets the value resultant from the subtraction as a new sell/buy profit. The process then goes back to step S10.

If the value resultant from the subtraction is a value equal to or smaller than 0 or the predetermined value (“NO” in step S14), the temporary sell/buy profit does not remain for a broker. The time determining unit 12 determines whether or not the current time is the end time of a private exchange (step S15). If the current time is not the end time of the private exchange and is an operation time (“NO” in step 15), the process goes back to step S3 where the operation for clinching a deal is again performed.

If the current time is the end time of the private exchange (“YES” in step S15), the process is terminated.

The above described operations of the deal process are more specifically explained. The following explanation assumes that a commodity is a stock certificate, and a commission calculation is ignored. Also assume that both a partial sell/buy prohibition is not set for sell and buy orders. However, these assumptions are not intended to limit the scope of the present invention.

Further assume that the sell/buy determining unit 13 obtains a sell order of a stock of a company A at a desired sell price 1000 yen by a quantity of 150, which is placed from an investor AX, and a buy order of the stock of the company A at a desired buy price 1500 yen by a quantity of 200, which is placed from an investor AY as a result of referencing the order data table within the storing unit 17.

The sell/buy determining unit 13 clinches a deal by determining to buy the stock of the company A at 1000 yen by 150 from the investor AX, and to sell the stock of the company A at 1500 yen by 150 to the investor AY. Furthermore, the sell/buy determining unit 13 leaves the order of the quantity of 50 stocks that are not dealt and remain in the order data table. As a result of this deal, the broker obtains (1500−1000)×150=75000 yen as a temporary profit in addition to the commission.

Next assume that the sell/buy determining unit 13 obtains from the order data table within the storing unit 17 the order of a stock of a company B whose industry type is the same as the stock of the company A and whose historical volatility is similar, and generates a pair of a sell order of the stock of the company B at a desired sell price 1200 yen by a quantity of 400 from an investor AW, and a buy order of the stock of the company B at a desired buy price 1000 yen by a quantity of 500 from an investor AZ.

In the case of this pair, the upper limit of the quantity that can be dealt is 75000/(1200−1000)=375 stocks.

Since the upper limit 375 of the quantity that can be dealt is smaller than the desired sell quantity 400 and the desired buy quantity 500, the sell/buy determining unit 13 determines 375 stocks as the quantity to be dealt of this order pair. The sell/buy determining unit 13 makes a deal to buy the stock of the company B at 1200 yen by 375 from the investor AW, and to sell the stock of the company B at 1000 yen by 375 to the investor AZ. Additionally, the sell/buy determining unit 13 leaves, in the order data table, the order of a quantity of 25 stocks that are not dealt and remain in the order of the investor AW, and the order of the stocks B by a quantity of 125 stocks that are not dealt and remain in the order of the investor AZ.

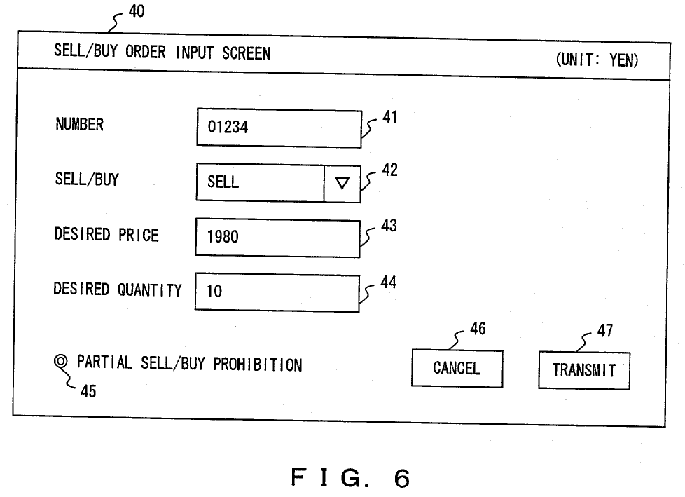

Next, one example of the screen that the display controlling unit 11 outputs to a terminal TA of an investor A is described. FIG. 6 exemplifies a sell/buy order input screen. As shown in FIG. 6, a sell/buy order input screen 40 includes a number (or symbol) input field 41, a sell/buy selection field 42, a desired price input field 43, and a desired quantity input field 44, a check field for specifying partial sell/buy prohibition 45, a cancel button 46, and a transmit button 47.

The number (or symbol) input field 41 is a field for inputting a number (or symbol) corresponding to a stock of a company that an investor A desires to sell/buy. The sell/buy selection field 42 is a field for selecting whether the investor A desires either to sell or to buy the stock. The desired price input field 43 and the desired quantity input field 44 are fields for inputting a price and a quantity at and by which the investor A desires to sell and buy the stock. If the investor A does not desire the state where only part of the ordered quantity is dealt, and the remainder is not dealt, he or she checks the check field 45. If the cancel button 46 is pressed, information input on the sell/buy order s15 input screen 40 is canceled. If the transmit button 47 is pressed, information input on the sell/buy order input screen 40 is transmitted to the deal processing apparatus 10, the display controlling unit 11 generates order data based on the received information, and stores the generated order data in the order data table within the storing unit 17.

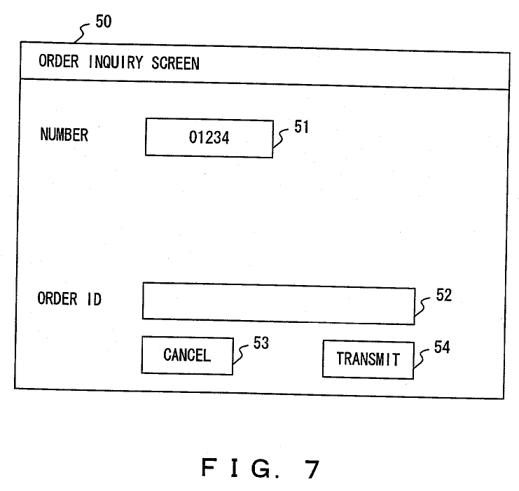

FIG. 7 exemplifies an order inquiry screen. As shown in this figure, an order inquiry screen 50 includes a number (or symbol) input field 51, an order ID input field 52, a cancel button 53, and a transmit button 54. The number (or symbol) input field 51, the cancel button 53, and the transmit button 54 were earlier explained with reference to FIG. 6. The order ID input field 52 is a filed for inputting an order ID to identify an order desired to be inquired about. When an investor A inputs a number (or symbol) or an order ID and presses the transmit button 54, the display controlling unit 11 obtains the information about the order from the storing unit 17 or a storing unit not shown, etc. by using the investor ID to identify the investor A, and the received stock number or order ID, sets the obtained information on the screen not shown, and notifies the investor A.

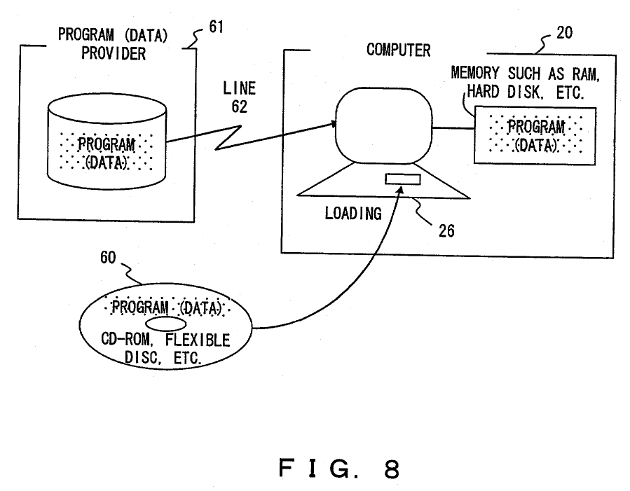

FIG. 8 explains computer-readable storage media and a transmission signal that can provide a program and data to the computer 20 shown in FIG. 4.

The above described program and data are prestored onto a computer-readable storage medium 60 so as to provide the program and the data stored in the tables. Then, the computer 20 is made to read the program, etc. from the storage medium 60 by using the medium driving device 26, and to once store the read program, etc. in the RAM 23 of the computer 20 or the external storage medium 25, and the CPU 22 comprised by the computer 20 is made to read and execute the stored program.

Additionally, the program may be downloaded from a database possessed by a program (data) provider 61 via a communications line (network) 62 instead of making the computer to read the program from the storage medium 60. In this case, for example, the computer that transmits the program obtains a transmission signal by converting the program data that represent the above described program into a program data signal, and by modulating the converted program data signal with a modem, and outputs the obtained transmission signal to the communications line 62. A computer that receives the program obtains a program data signal by demodulating the received transmission signal by using a modem, and obtains the program data by converting the obtained program data signal. If the communications line 62 that interconnects the computers on the transmitting and receiving sides is a digital line, also the program and data signal can be communicated. Additionally, a computer of a telephone office, etc. may be interposed between the computer that transmits the program and the computer 20 that downloads the program.

Up to this point, the preferred embodiment according to the present invention is described. However, the present invention is not limited to the above described embodiment, and various modifications may be made.

For example, in the preferred embodiment, the deal processing apparatus 10 is explained by comprising the volatility calculating unit 15 and the security selecting unit 16. However, the deal processing apparatus may not comprise the volatility calculating unit 15 and the security selecting unit 16. In this case, the sell/buy determining unit 13 generates a pair of sell and buy orders without considering historical volatilities.

Furthermore, for example, the above explanation refers to the clinching of a deal in which a desired buy price is lower than a desired sell price until a sell/buy profit becomes a predetermined value such as 0, after a broker obtains the temporary sell/buy profit by clinching a deal in which a desired sell price is lower than a desired buy price. However, a deal in which a desired sell price is lower than a desired buy price may be clinched until a sell/buy loss becomes a predetermined value, after a broker obtains the temporary sell/buy loss by earlier clinching a deal in which a desired buy price is lower than a desired sell price.

As described above in detail, according to the present invention, a deal can be clinched while keeping the risk that a broker who intermediates orders suffers a sell and buy loss, even if a desired sell price of a sell order and a desired buy price of a buy order do not match.

While the invention has been described with reference to the preferred embodiments thereof, various modifications and changes may be made to those skilled in the art without departing from the true spirit and scope of the invention as defined by the claims thereof.

What is claimed is:

1. A dealing method clinching a deal by intermediating a sell order and a buy order, comprising:
clinching a first deal if a desired sell price of a sell order is lower than a desired buy price of a buy order in the first deal;
calculating a sell/buy profit made by clinching the first deal;
calculating a sell/buy loss incurred by clinching a second deal if a desired buy price of a buy order is lower than a desired sell price of a sell order in the second deal; and
clinching the second deal if a value obtained by subtracting the sell/buy loss from the sell/buy profit is equal to or larger than a predetermined value.

2. The dealing method according to claim 1, further comprising
determining a smaller quantity of a quantity in the sell order in the first deal and a quantity in the buy order in the first deal as a quantity to be dealt in the first deal.

3. The dealing method according to claim 1, further comprising
determining a quantity to be dealt in the second deal based on the sell/buy profit in the first deal, the desired buy and sell prices in the second deal.

4. The dealing method according to claim 1, further comprising:
calculating a desired sell/buy price difference, which is a difference between the desired buy price of the buy order in the second deal and the desired sell price of the sell order in the second deal;
calculating an upper limit quantity to be dealt by dividing the sell/buy profit by the desired sell/buy price difference; and
determining a smallest quantity among the upper limit quantity to be dealt, a quantity in the sell order in the second deal, and a quantity in the buy order in the second deal as a quantity to be dealt in the second deal.

5. The dealing method according to claim 1, further comprising:
calculating a historical volatility of a price of a commodity dealt in the first deal to time;
calculating a historical volatility of a price of a commodity dealt in the second deal to time; and
not clinching the second deal if the historical volatility of the commodity dealt in the first deal and the historical volatility of the commodity dealt in the second deal do not have a predetermined relationship.

6. The dealing method according to claim 5, wherein:
the commodity is a stock certificate; and further comprising
not clinching the second deal if an industry type to which the first commodity belongs is not the same as an industry type to which the second commodity belongs.

7. The dealing method according to claim 1, further comprising:
setting a value obtained by subtracting the sell/buy loss from the sell/buy profit as a new sell/buy profit, if the value is determined to be larger than a predetermined value as a result of making the second deal; and
clinching a third deal in which a desired buy price of a buy order is lower than a desire sell price of a sell order.

8. A dealing method clinching a deal by intermediating a sell order and a buy order, comprising:
clinching a first deal if a desired sell price of a sell order is higher than a desired buy price of a buy order in the first deal;
calculating a sell/buy loss incurred by clinching the first deal;
clinching a second deal if a desired buy price of a buy order is higher than a desired sell price of a sell order in the second deal;
calculating a sell/buy profit made by the second deal; and
clinching a third deal in which a desired buy price of a buy order is lower than a desired sell price of a sell order if a value obtained by subtracting the sell/buy profit in the second deal from the sell/buy loss in the first deal is not equal to or smaller than a predetermined value.

9. A computer data signal embodied in a carrier wave and representing a program for causing a computer to execute a process for clinching a deal by intermediating a sell order and a buy order, the process comprising:
clinching a first deal if a desired sell price of a sell order is lower than a desired buy price of a buy order in the first deal;
calculating a sell/buy profit made by clinching the first deal;
calculating a sell/buy loss incurred by clinching a second deal if a desired buy price of a buy order is lower than a desired sell price of a sell order in the second deal; and
clinching the second deal if a value obtained by subtracting the sell/buy loss from the sell/buy profit is equal to or larger than a predetermined value.

10. A computer-readable storage medium on which is recorded a program for causing a compute to execute a process for clinching a deal by intermediating a sell order and a buy order, the process comprising:
clinching a first deal if a desired sell price of a sell order is lower than a desired buy price of a buy order in the first deal;
calculating a sell/buy profit made by clinching the first deal;
calculating a sell/buy loss incurred by clinching a second deal if a desired buy price of a buy order is lower than a desired sell price of a sell order in the second deal; and
clinching the second deal if a value obtained by subtracting the sell/buy loss from the sell/buy profit is determined to be equal to or larger than a predetermined value.

11. A deal processing apparatus clinching a deal by intermediating a sell order and a buy order, comprising:
an accepting unit accepting a sell order and a buy order; and
a sell/buy determining unit clinching a deal by determining a pair of a sell order and a buy order, wherein
said sell/buy determining unit clinches a first deal if a desired sell price of a sell order is lower than a desired buy price of a buy order in the first deal, calculates a sell/buy profit made by clinching the first deal, calculates a sell/buy loss incurred by clinching a second deal if a desired buy price of a buy order is lower than a desired sell price of a sell order in the second deal, and clinches the second deal if a value obtained by subtracting the sell/buy loss from the sell/buy profit is equal to or larger than a predetermined value.

12. A deal assisting method assisting a deal of a security, comprising:
selecting a pair of first and second securities from a storing unit;
setting a smaller quantity of a first desired buy quantity of the first security and a first desired sell quantity of the first security as a first sell/buy quantity of the first security, if a first desired buy price of the first security is higher than a first desired sell price of the first security, and if a second desired price of the second security is higher than a second buy price of the second security;
selling the first security by the first sell/buy quantity at the first desired buy price;
buying the first security by the first sell/buy quantity at the first desired sell price;
calculating a sell/buy profit obtained by selling and buying the first security;
calculating a price difference by subtracting the second desired buy price of the second security from the second desired sell price of the second security;
calculating a sell/buy upper limit quantity by dividing the sell/buy profit by the price difference;
setting a smallest quantity among 3 quantities such as the second desired sell quantity of the second security, the second desired buy quantity of the second security, and the sell/buy upper limit quantity as a second sell/buy quantity of the second security;
selling the second security by the second sell/buy quantity at the second desired buy price; and
buying the second security by the second sell/buy quantity at the second desired sell price.
